(19) United States
(12) Patent Application Publication
(10) Pub. No.: US 2023/0268649 A1
(43) Pub. Date: Aug. 24, 2023

(54) CIRCULARLY POLARIZED SIGNAL VIA THREE LINEARLY POLARIZED ANTENNAS

(71) Applicant: Microsoft Technology Licensing, LLC, Redmond, WA (US)

(72) Inventor: Marshall Joseph KATZ, Seattle, WA (US)

(73) Assignee: Microsoft Technology Licensing, LLC, Redmond, WA (US)

(21) Appl. No.: 18/163,116

(22) Filed: Feb. 1, 2023

(30) Foreign Application Priority Data
Feb. 18, 2022 (NL) 2031007

(51) Int. Cl. H01Q 3/36; H01Q 1/24; H01Q 3/28; H01Q 1/22

(52) U.S. Cl. CPC H01Q 3/36; H01Q 1/243; H01Q 3/28; H01Q 1/2266

(57) ABSTRACT

Examples are disclosed that relate to handling a circularly polarized signal via a plurality of linearly polarized antennas. One example provides a mobile device comprising an inertial measurement unit (IMU) and an antenna system configured for communication using a circularly polarized signal. The antenna system comprises a first linearly polarized antenna, a second linearly polarized antenna, a third linearly polarized antenna, and a processing stage. The processing stage is configured to adjust, based at least in part on data from the IMU, one or more of a phase or a gain of a signal on each of the first, second, and third linearly polarized antennas to direct a beam of the antenna system toward a direction of the circularly polarized signal.

### CROSS REFERENCE TO RELATED APPLICATIONS

This application claims priority to Netherlands Patent Application Serial Number 2031007, filed Feb. 18, 2022, the entirety of which is hereby incorporated herein by reference for all purposes.

### BACKGROUND

Circularly polarized antennas may be positioned such that a beam of the antenna is directed toward a direction of a source a circularly polarized signal. As an example, a global positioning system (GPS) receiver may comprise a right hand circularly polarized (RHCP) antenna having a beam aligned with reference to gravity to receive a RHCP signal from a GPS satellite.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to handling a circularly polarized signal via a plurality of linearly polarized antennas. One example provides a mobile device comprising an inertial measurement unit (IMU) and an antenna system configured for communication using a circularly polarized signal. The antenna system comprises a first linearly polarized antenna, a second linearly polarized antenna, a third linearly polarized antenna, and a processing stage. The processing stage is configured to adjust, based at least in part on data from the IMU, one or more of a phase or a gain of a signal on each of the first, second, and third linearly polarized antennas to direct a beam of the antenna system toward a direction of the circularly polarized signal.

### BRIEF DESCRIPTION OF THE DRAWINGS

FIG. 1 shows an example mobile device.

FIG. 2 shows an example circularly polarized signal.

FIG. 3 shows example multipath signal interference.

FIG. 4 shows another example mobile device.

FIG. 5 shows a block diagram of an example mobile device.

FIG. 6 shows a block diagram of another example mobile device.

FIG. 7 shows a flow diagram of an example method for receiving a circularly polarized signal.

FIG. 8 shows a flow diagram of an example method for transmitting a circularly polarized signal.

FIG. 9 shows a block diagram of an example computing system.

### DETAILED DESCRIPTION

A circularly polarized antenna utilized in a GPS receiver may be positioned so that a beam of the circularly polarized antenna is aligned with reference to gravity. The use of a circularly polarized signal may help to reduce multipath interference. Multipath interference occurs when a signal reflects from an object and then is received by an antenna. The reflection causes a time delayed signal compared to a direct path signal, thereby interfering with the direct path signal. However, a circularly polarized signal may reflect in such a manner that a polarization handedness may reverse, depending upon an angle of reflection. As a specific example, a RHCP signal may reverse polarization and reflect as a left hand circularly polarized (LHCP) signal when the angle of reflection exceeds the Brewster's angle. In this example, a RHCP antenna filters the LHCP signal resulting from the reflection. As such, the use of a circularly polarized signal for GPS may help to avoid location errors that arise from multipath interference.

However, a mobile device, such as a phone, laptop or tablet, may have different device orientations as the device is handled by a user. If a beam of a circularly polarized antenna on the mobile device has a fixed direction relative to the device, the beam often may be directed in directions other than toward a circularly polarized signal. This may reduce a received power of the circularly polarized signal. Further, a RHCP antenna oriented away from a signal source can act as a LHCP antenna with respect to the signal source, and thereby filter the signal.

One possible solution to avoid such orientation-related issues on a mobile device is to use a linearly polarized antenna to receive the circularly polarized signal. However, a mismatch of a polarization between the circularly polarized signal and the linearly polarized antenna may reduce a received signal strength. For example, the linearly polarized antenna may lose approximately 3 dB of the circularly polarized signal. Further, the linearly polarized antenna may not filter a circularly polarized signal that has reflected and reversed in handedness.

Accordingly, examples are disclosed that relate to control of a beam direction of an antenna system for receiving and/or transmitting circularly polarized signals on a mobile device. Briefly, the disclosed examples utilize an IMU and an antenna system. The antenna system comprises at least three linearly polarized antennas. In some examples, the three linearly polarized antennas are arranged orthogonally to each other. In other examples, the three linearly polarized antennas have any other suitable arrangement relative to one another. A processing stage of the antenna system is configured to adjust, based at least in part on data from the IMU, one or more of a phase or a gain of a signal on each of the three linearly polarized antennas to direct a beam of the antenna system toward a direction of the circularly polarized signal. In such a manner, the beam of the antenna system can be directed without changing a physical orientation of the antenna system. In some examples the antenna system receives the circularly polarized signal, such as a GPS signal. In other examples, the antenna system transmits the circularly polarized signal. The use of a plurality of linearly polarized antennas may enable the antenna system to adjust a beam direction to direct the beam toward the direction of the circularly polarized signal for different device orientations. In the examples when the antenna system receives the GPS signal, a location error may be reduced compared to receiving the GPS signal via a single linearly polarized antenna.

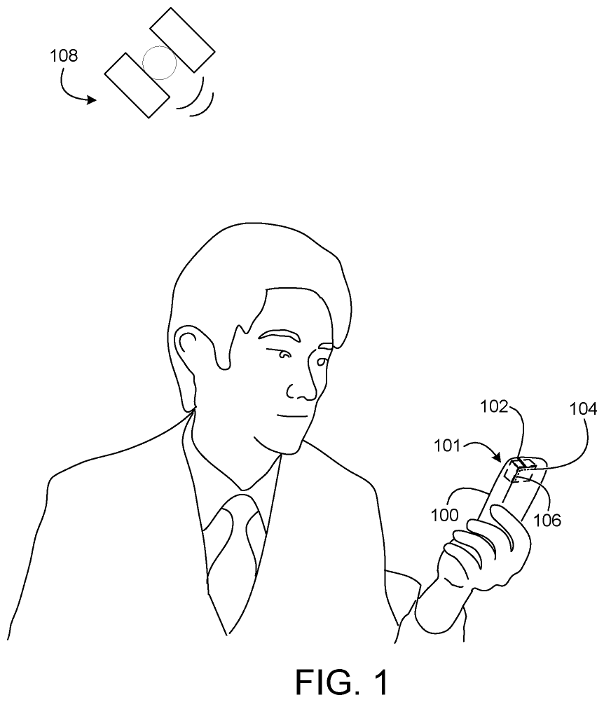

FIG. 1 shows an example mobile device 100 in the form of a smartphone. Mobile device 100 comprises an antenna system 101 comprising a first linearly polarized antenna 102, a second linearly polarized antenna 104, and a third linearly polarized antenna 106. In the depicted example, antenna system 101 is configured to receive RHCP signals from a GPS satellite system comprising GPS satellite 108. In other examples, antenna system 101 can be configured to receive any other suitable circularly polarized signal. In the depicted example, first linearly polarized antenna 102, second linearly polarized antenna 104, and third linearly polarized antenna 106 are arranged orthogonally to each other. Such a configuration may help to increase a received power of the RHCP signals over a range of relative orientations of mobile device 100 compared to other antenna arrangements. In other examples, as mentioned above, a first linearly polarized antenna, second linearly polarized antenna, and third linearly polarized antenna can have any other suitable arrangement relative to each other. Further, first linearly polarized antenna 102, second linearly polarized antenna 104, and third linearly polarized antenna 106 can be positioned at any suitable locations relative to on other, such as within a half a wavelength of each other, with reference to a wavelength of a signal being transmitted and/or received. A relative location of within half the wavelength may help to improve an efficiency of antenna system 101 relative to greater spacings between antennas. In the depicted example, first linearly polarized antenna 102 is located on an edge of mobile device 100, and second linearly polarized antenna 104 and third linearly polarized antenna 106 are located internal to mobile device 100. In some such examples, second linearly polarized antenna 104 and third linearly polarized antenna 106 can be located on a printed circuit board (PCB). In other examples, first linearly polarized antenna 102, second linearly polarized antenna 104, and third linearly polarized antenna 106 can have any other suitable locations.

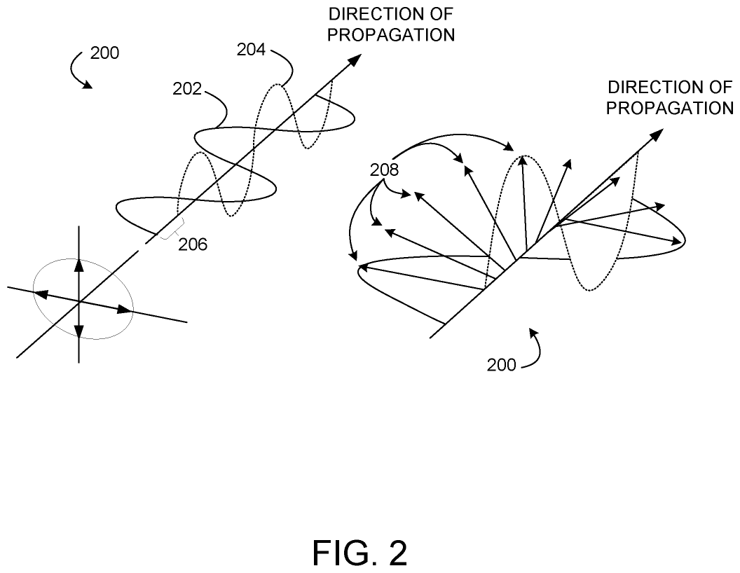

FIG. 2 illustrates an example circularly polarized signal 200. Mobile device 100 may receive circularly polarized signal 200 as an example. Circularly polarized signal 200 comprises a first electric field 202 and a second electric field 204 with a phase difference 206. In some examples, first electric field 202 and second electric field 204 can have the same magnitude, or any suitable relative magnitude in other examples. In some examples, phase difference 206 can be 90 degrees. In other examples, phase difference 206 can have any other suitable magnitude. In the depicted example, circularly polarized signal 200 is a RHCP signal as indicated by a right-handed rotation of electric field vectors 208. In other examples, circularly polarized signal 200 can be a LHCP signal with electric field vectors 208 rotating in a left-handed manner. The term “circularly polarized” as used herein also refers to elliptically polarized signals, in which the phase difference and/or magnitudes of the electric fields are out of phase by a difference other than 90 degrees and/or the fields have different magnitudes.

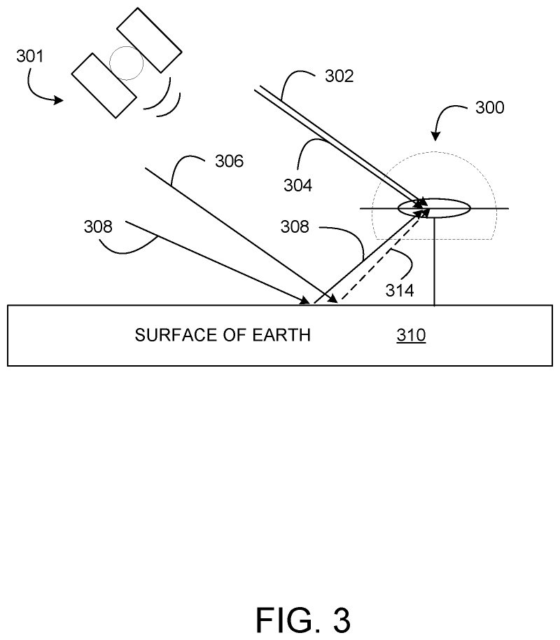

As previously mentioned, a signal taking multiple paths to reach an antenna receiver may result in multipath interference. FIG. 3 depicts such multipath interference in the example of a GPS signal received by a base station 300. GPS satellite 301 radiates a RHCP signal along paths including first path 302, second path 304, third path 306, and fourth path 308. First path 302 and second path 304 are direct paths to base station 300. In contrast, third path 306 and fourth path 308 are non-direct paths each comprising a reflection off of a surface of earth 310. The non-direct path may increase a determined distance between GPS satellite 301 and base station 300, and may cause an error in the location of base station 300. In this example, third path 306 reflects with an incident angle greater than the Brewster's angle, and thus a RHCP signal traveling along third path 306 reverses handedness to create a LHCP signal traveling along fifth path 314. In contrast, fourth path 308 reflects with an incident angle less than the Brewster's angle, and does not reverse polarization.

As previously mentioned, a RHCP antenna can filter out a LHCP signal. In some examples, base station 300 can comprise a RHCP antenna positioned such that a beam of the RHCP antenna is aligned with reference to gravity. Such a configuration may help base station 300 to filter out LHCP signals, such as the LHCP signal traveling along fifth path 314. This may help to reduce multipath interference and resulting location errors at base station 300.

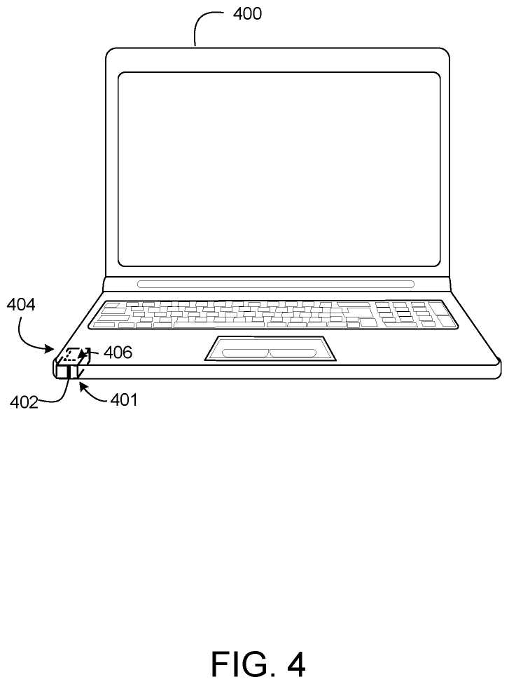

However, unlike a base station, a mobile device does not have a fixed position with reference to the ground. Thus, referring again to FIG. 1, antenna system 101 of mobile device 100 utilizes linearly polarized antennas 102, 104, and 106 to receive RHCP signals from a GPS satellite system. Mobile device 100 is one example of a mobile device that utilizes a plurality of linearly polarized antennas to transmit and/or receive circularly polarized signals, and other types of mobile devices also may use such an antenna system. FIG. 4 shows another example mobile device 400 in the form of a laptop computer that utilizes an antenna system comprising a plurality of linearly polarized antennas to transmit and/or receive circularly polarized signals. More particularly, mobile device 400 comprises an antenna system 401 comprising a first linearly polarized antenna 402, a second linearly polarized antenna 404, and a third linearly polarized antenna 406. In some examples, antenna system 401 is configured to receive the circularly polarized signal from a circularly polarized signal source. In other examples, antenna system 401 is configured to transmit the circularly polarized signal directed towards a circularly polarized signal receiver. Other examples of mobile device that may utilize such an antenna system include tablets, head-mounted devices, and other wearable devices, such as wrist-worn device.

In this example, first linearly polarized antenna 402, second linearly polarized antenna 404, and third linearly polarized antenna 406 are arranged orthogonally to each other. In other examples, first linearly polarized antenna 402, second linearly polarized antenna 404, and third linearly polarized antenna 406 can have any other suitable relative arrangement relative to each other. Further, first linearly polarized antenna 402, second linearly polarized antenna 404, and third linearly polarized antenna 406, can be positioned at any suitable spacings from one another. Examples include spacings that are within a half a wavelength of each other, with reference to a wavelength of a transmitted and/or received signal. In the depicted example, first linearly polarized antenna 402 is located on an edge of mobile device 400, and second linearly polarized antenna 404 and third linearly polarized antenna 406 are located internal to mobile device 400. Such a configuration may decrease an amount of space occupied by first linearly polarized antenna 402, second linearly polarized antenna 404, and third linearly polarized antenna 406 compared to configurations that place all antennas on circuit boards in an interior of a device. In some such examples, second linearly polarized antenna 404 and third linearly polarized antenna 406 can be located on a PCB. In other examples, first linearly polarized antenna 402, second linearly polarized antenna 404, and third linearly polarized antenna 406 can have any other suitable locations.

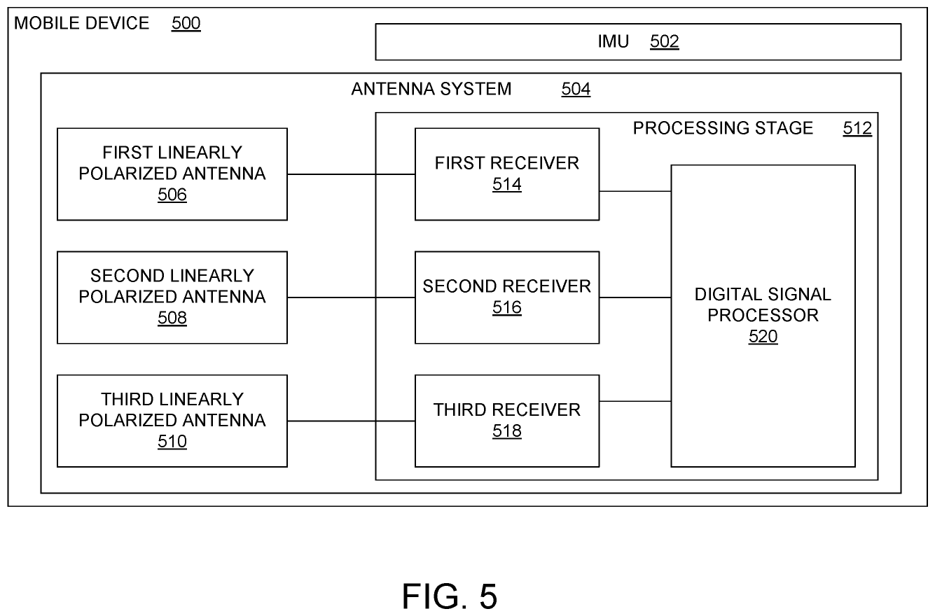

FIG. 5 shows a block diagram of an example mobile device 500. Mobile device 100 and mobile device 400 are examples of mobile device 500. Mobile device 500 comprises an IMU 502, and an antenna system 504 comprising a first linearly polarized antenna 506, a second linearly polarized antenna 508, a third linearly polarized antenna 510, and a processing stage 512. Antenna system 504 is configured to receive a circularly polarized signal. In some examples, the circularly polarized signal comprises a RHCP signal, such as a GPS signal. In other examples, circularly polarized signal may comprise any other suitable circularly polarized signal. In some examples, first linearly polarized antenna 506, second linearly polarized antenna 508, and third linearly polarized antenna 510 are arranged orthogonally to each other. In other examples, first linearly polarized antenna 506, second linearly polarized antenna 508, and third linearly polarized antenna 510 can have any other suitable arrangement relative to each other.

Processing stage 512 comprises a first receiver 514 connected to first linearly polarized antenna 506, a second receiver 516 connected to second linearly polarized antenna 508, a third receiver 518 connected to third linearly polarized antenna 510, and a digital signal processor 520 connected to first receiver 514, second receiver 516, and third receiver 518. Processing stage 512 is configured to adjust, based at least in part on data from IMU 502, one or more of a phase or a gain of a signal on each of first linearly polarized antenna 506, second linearly polarized antenna 508, and third linearly polarized antenna 510 to direct a beam of antenna system 504 toward a direction of the circularly polarized signal. Such a configuration may help to increase a received power of the circularly polarized signal. In some examples, the direction can comprise a direction aligned with reference to gravity. The direction can comprise a direction toward a GPS satellite, or any other suitable direction. Such a configuration may increase a received power of a GPS signal received from the GPS satellite. Further, the antenna system 504 may filter out circularly polarized signals of an opposite handedness as the signal being received. This may help to mitigate multipath interference, as described above.

In the depicted example, first receiver 514 adjusts the signal on first linearly polarized antenna 506, second receiver 516 adjusts the signal on second linearly polarized antenna 508, and third receiver 518 adjusts the signal on third linearly polarized antenna 510. In other examples, the phase of each signal can be adjusted via components external to antenna system 504. In various examples, processing stage 512 can be configured to adjust the one or more of the phase or the gain continuously (e.g. at a selected update frequency), or in response to a suitable trigger, such as a threshold change in device orientation as determined via data from IMU 502. In examples where antenna system 504 is configured to receive the GPS signal, a received power of the GPS signal via antenna system 504 may be higher than received power of the GPS signal via a single linearly polarized antenna, for example, by 3 dB. Digital signal processor 520 can be configured to combine the signals adjusted, and decode the combined signals. In some examples, mobile device 500 may further comprise other components (not shown) for transmitting a circularly polarized signal.

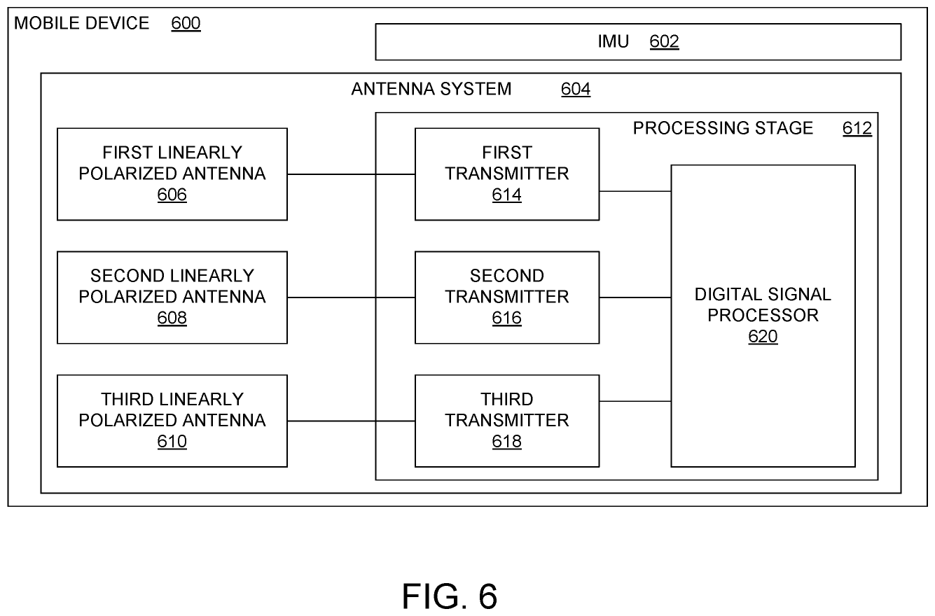

FIG. 6 shows a block diagram of another example mobile device 600. Mobile device 100 or mobile device 400 may be examples of mobile device 600. Mobile device 600 comprises an IMU 602, an antenna system 604 comprising a first linearly polarized antenna 606, a second linearly polarized antenna 608, a third linearly polarized antenna 610, and a processing stage 612. Antenna system 604 is configured to transmit a circularly polarized signal. In some examples, the circularly polarized signal comprises a RHCP signal. In other examples, circularly polarized signal may comprise a LHCP signal. Transmitting the RHCP signal and/or the LHCP signal may help to reduce multipath interference at a receiver of the circularly polarized signal. In some examples, first linearly polarized antenna 606, second linearly polarized antenna 608, and third linearly polarized antenna 610 are arranged orthogonally to each other. In other examples, first linearly polarized antenna 606, second linearly polarized antenna 608, and third linearly polarized antenna 610 can have any other suitable relative angle to each other.

Processing stage 612 comprises a first transmitter 614 connected to first linearly polarized antenna 606, a second transmitter 616 connected to second linearly polarized antenna 608, a third transmitter 618 connected to third linearly polarized antenna 610, and a digital signal processor 620 connected to first transmitter 614, second transmitter 616, and third transmitter 618. Processing stage 612 is configured to adjust, based at least in part on data from IMU 602, one or more of a phase or a gain of a signal on each of first linearly polarized antenna 606, second linearly polarized antenna 608, and third linearly polarized antenna 610 to direct a beam of antenna system 604 toward a direction of a receiver.

In the depicted example, first transmitter 614 adjusts the signal on first linearly polarized antenna 606, second transmitter 616 adjusts the signal on second linearly polarized antenna 608, and third transmitter 618 adjusts the signal on third linearly polarized antenna 610. In some examples, processing stage 612 can be configured to adjust the one or more of the phase or the gain continuously, for example based upon a selected update frequency. In other examples, processing stage 612 can be configured to adjust the one or more of the phase or the gain for each antenna based upon a suitable trigger, such as a threshold change in device orientation as sensed by IMU 602. or in any other suitable manner. Such a configuration may allow processing stage 612 to direct the beam of antenna system 604 toward the direction of the circularly polarized signal upon a change in an orientation of mobile device 600. Digital signal processor 520 can be configured to divide a signal to transmit into a signal for first linearly polarized antenna 606, a signal for second linearly polarized antenna 608, and a signal for third linearly polarized antenna 610. In some examples, mobile device 600 may further comprise other components (not shown) for receiving a circularly polarized signal.

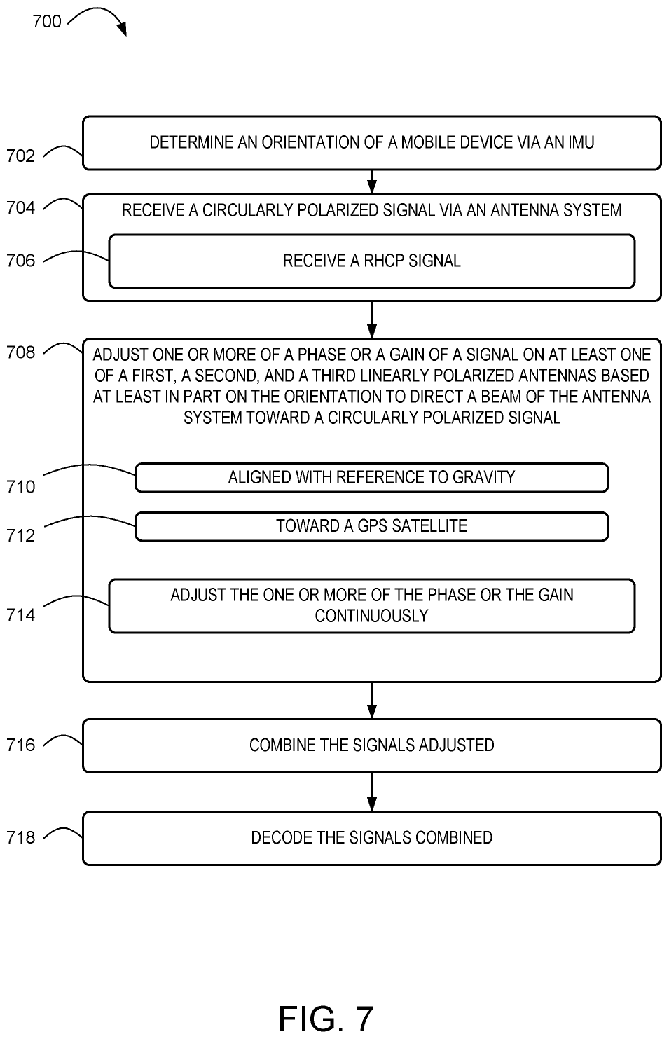

FIG. 7 depicts a flow diagram depicting example method 700 for receiving a circularly polarized signal via three linearly polarized antennas. Method 700 may be performed on mobile device 100, mobile device 400, mobile device 500, or mobile device 600, as examples. Method 700 comprises, at 702, determining an orientation of a mobile device via data from an IMU of the mobile device. Method 700 further comprises, at 704, receiving a circularly polarized signal via an antenna system of the mobile device. The antenna system comprises a first, a second, and a third linearly polarized antennas. In some examples, the antennas are arranged orthogonally to each other. In other examples, the antennas may have any other suitable relative angle to one another. In some examples, method 700 comprises receiving a RHCP signal at 706, such as from a GPS satellite. In other examples, a LHCP signal may be received.

Continuing, method 700 comprises, at 708, adjusting one or more of a phase or a gain of a signal on at least one of the first, second, and third linearly polarized antennas based at least in part on the orientation and to direct a beam of the antenna system toward a direction of the circularly polarized signal. Directing the beam in such a manner may increase a received power of the circularly polarized signal. In some examples, the direction comprises a direction aligned with reference to gravity, as indicated at 710. Such a direction may be towards a GPS satellite, at 712, or toward any other suitable direction. In some examples, as indicated at 714, the one or more of the phase or gain may be adjusted continuously, for example, based upon a selected update frequency. In other examples, the one or more of the phase or the gain may be adjusted based upon a threshold change in orientation of the mobile device, or upon any other suitable trigger. Method 700 additionally comprises combining, at 716, the signals adjusted on the first, second, and third linearly polarized antennas, and decoding, at 718, the combined signals.

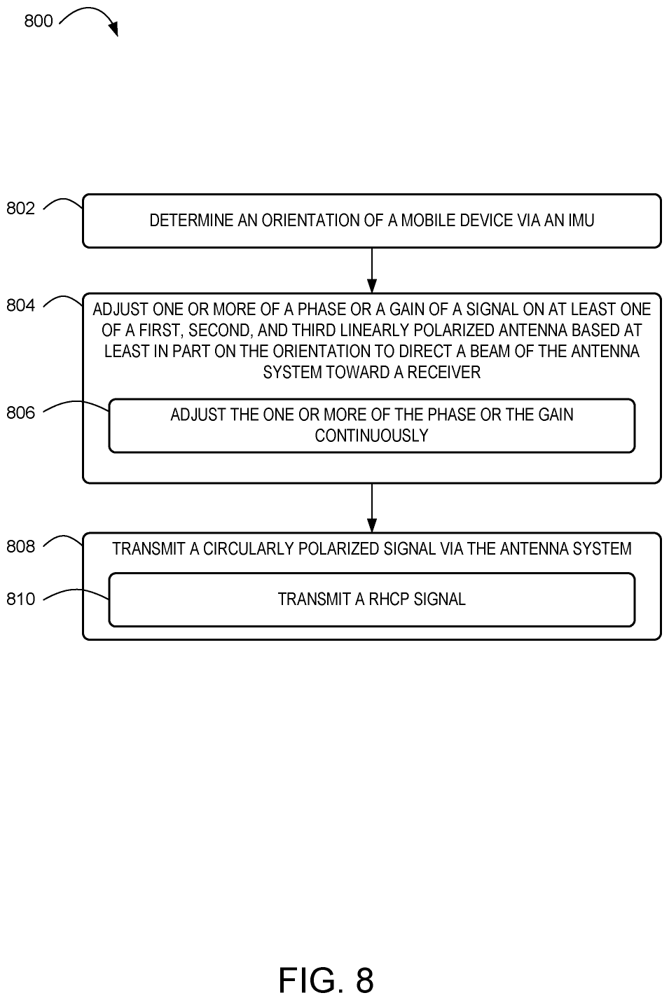

FIG. 8 depicts a flow diagram for an example method 800 for transmitting a circularly polarized signal via three linearly polarized antennas. Method 800 may be performed on any of mobile device 100, mobile device 400, mobile device 500, and/or mobile device 600, as examples. Method 800 comprises, at 802, determining an orientation of a mobile device via an IMU of the mobile device. Method 800 comprises, at 804, adjusting one or more of a phase or a gain of a signal on at least one of a first, second, and third linearly polarized antennas of an antenna system based at least in part on the orientation and to direct a beam of the antenna system toward a receiver of the circularly polarized signal. Directing the beam in such a manner may increase an amount of transmitted power of the circularly polarized signal directed toward the receiver. In some examples, the first, second, and third linearly polarized antennas are arranged orthogonally to each other. In other examples, the antennas are arranged at any other suitable relative angle(s) to one another. In some examples, as indicated at 806, the one or more of the phase of the gain may be adjusted continuously, such as according to a selected update frequency. In other examples, the one or more of the phase or the gain may be adjusted based upon a threshold change in orientation of the mobile device, or upon any other suitable trigger. Continuing, method 800 comprises, at 808, transmitting a circularly polarized signal via the antenna system based at least in part on the one or more of the phase or the gain adjusted of the signal on the at least one of the first, second, and third linearly polarized antennas. In some examples, method 800 comprises transmitting a RHCP signal, at 810. In other examples, method 800 comprises transmitting a LHCP signal.

Thus, a mobile device may utilize an antenna system comprising a plurality of linearly polarized antennas as described herein to help direct a beam of the antenna system toward a direction of a circularly polarized signal, and update the direction as an orientation of the mobile device changes. This may help increase a received power of the circularly polarized signal relative to the use of a single linearly polarized antenna.

In some embodiments, the methods and processes described herein may be tied to a computing system of one or more computing devices. In particular, such methods and processes may be implemented as a computer-application program or service, an application-programming interface (API), a library, and/or other computer-program product.

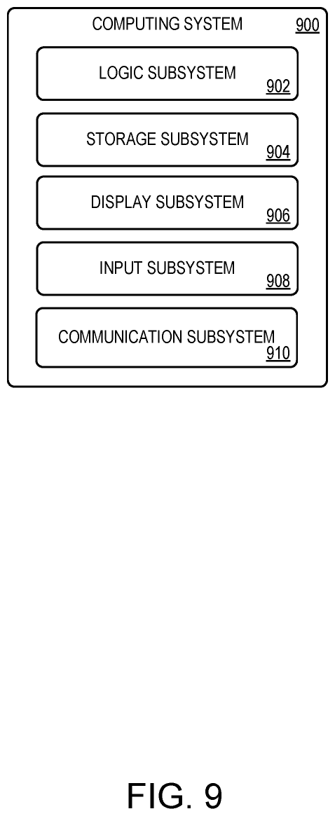

FIG. 9 schematically shows a non-limiting embodiment of a computing system 900 that can enact one or more of the methods and processes described above. Computing system 900 is shown in simplified form. Computing system 900 may take the form of one or more personal computers, server computers, tablet computers, home-entertainment computers, network computing devices, gaming devices, mobile computing devices, mobile communication devices (e.g., smart phone), and/or other computing devices. Mobile device 100, mobile device 400, mobile device 500, and mobile device 600 are examples of computing system 900.

Computing system 900 includes a logic subsystem 902 and a storage subsystem 904. Computing system 900 may optionally include a display subsystem 906, input subsystem 908, communication subsystem 910, and/or other components not shown in FIG. 9.

Logic subsystem 902 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage subsystem 904 includes one or more physical devices configured to hold instructions executable by the logic machine to implement the methods and processes described herein. When such methods and processes are implemented, the state of storage subsystem 904 may be transformed—e.g., to hold different data.

Storage subsystem 904 may include removable and/or built-in devices. Storage subsystem 904 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 904 may include volatile, nonvolatile, dynamic, static, read/write, read-only, random-access, sequential-access, location-addressable, file-addressable, and/or content-addressable devices.

It will be appreciated that storage subsystem 904 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 902 and storage subsystem 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, display subsystem 906 may be used to present a visual representation of data held by storage subsystem 904. This visual representation may take the form of a graphical user interface (GUI). As the herein described methods and processes change the data held by the storage machine, and thus transform the state of the storage machine, the state of display subsystem 906 may likewise be transformed to visually represent changes in the underlying data. Display subsystem 906 may include one or more display devices utilizing virtually any type of technology. Such display devices may be combined with logic subsystem 902 and/or storage subsystem 904 in a shared enclosure, or such display devices may be peripheral display devices.

When included, input subsystem 908 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 910 may be configured to communicatively couple computing system 900 with one or more other computing devices. Communication subsystem 910 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

Another example provides a mobile device comprising an inertial measurement unit, IMU, and an antenna system configured for communication using a circularly polarized signal, the antenna system comprising a first linearly polarized antenna, a second linearly polarized antenna, a third linearly polarized antenna, and a processing stage configured to adjust, based at least in part on data from the IMU, one or more of a phase or a gain of a signal on each of the first, second, and third linearly polarized antennas to direct a beam of the antenna system toward a direction of the circularly polarized signal. In some such examples, the antenna system is alternatively or additionally configured to receive the circularly polarized signal. In some such examples, the direction alternatively or additionally comprises a direction aligned with reference to gravity. In some such examples, the direction alternatively or additionally comprises a direction toward a global positioning system, GPS, satellite. In some such examples, the antenna system is alternatively or additionally configured to transmit the circularly polarized signal. In some such examples, the circularly polarized signal alternatively or additionally comprises a right hand circularly polarized, RHCP, signal. In some such examples, the first, second, and third linearly polarized antennas are alternatively or additionally positioned within a half a wavelength of each other. In some such examples, the wavelength alternatively or additionally comprises a global positioning system, GPS, wavelength. In some such examples, one or more of the first, second, or third linearly polarized antennas is alternatively or additionally located on an edge of the device.

Another example provides, on a mobile device comprising an inertial measurement unit (IMU), and an antenna system comprising a first, a second, and a third linearly polarized antennas, a method comprising determining an orientation of the device via the IMU, receiving a circularly polarized signal via the antenna system, adjusting one or more of a phase or a gain of a signal on at least one of the first, second, and third linearly polarized antennas based at least in part on the orientation. In some such examples, the method alternatively or additionally comprises combining the signals adjusted on the first, second, and third linearly polarized antennas, and decoding the signals combined. In some such examples, adjusting the one or more of the phase or the gain alternatively or additionally comprises adjusting the one or more of the phase or the gain to direct a beam of the antenna system toward a direction of the circularly polarized signal. In some such examples, the direction alternatively or additionally comprises a direction aligned with reference to gravity. In some such examples, the direction alternatively or additionally comprises a direction toward a global positioning system, GPS, satellite. In some such examples, receiving the circularly polarized signal alternatively or additionally comprises receiving a right hand circularly polarized, RHCP, signal. In some such examples, adjusting the one or more of the phase or the gain alternatively or additionally comprises adjusting the one or more of the phase or the gain continuously.

Another example provides, on a mobile device comprising an inertial measurement unit, IMU, and an antenna system comprising a first, a second, and a third linearly polarized antennas, a method comprising determining an orientation of the device via the IMU, adjusting one or more of a phase or a gain of a signal on at least one of the first, second, and third linearly polarized antennas based at least in part on the orientation, and transmitting a circularly polarized signal via the antenna system based at least in part on the one or more of the phase or the gain adjusted of the signal on the at least one of the first, second, and third linearly polarized antennas. In some such examples, adjusting the one or more of the phase or the gain alternatively or additionally comprises, adjusting the one or more of the phase or the gain to direct a beam of the antenna system toward a receiver of the circularly polarized signal. In some such examples, transmitting the circularly polarized signal alternatively or additionally comprises transmitting a right hand circularly polarized (RHCP) signal. In some such examples, adjusting the one or more of the phase or the gain alternatively or additionally comprises adjusting the one or more of the phase or the gain continuously.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A mobile device comprising:
an inertial measurement unit, IMU; and
an antenna system configured for communication using a circularly polarized signal, the antenna system comprising
a first linearly polarized antenna,
a second linearly polarized antenna,
a third linearly polarized antenna, and
a processing stage configured to adjust, based at least in part on data from the IMU, one or more of a phase or a gain of a signal on each of the first, second, and third linearly polarized antennas to direct a beam of the antenna system toward a direction of the circularly polarized signal.

2. The device of claim 1, wherein the antenna system is configured to receive the circularly polarized signal.

3. The device of claim 1, wherein the direction comprises a direction aligned with reference to gravity.

4. The device of claim 1, wherein the direction comprises a direction toward a global positioning system, GPS, satellite.

5. The device of claim 1, wherein the antenna system is configured to transmit the circularly polarized signal.

6. The device of claim 1, wherein the circularly polarized signal comprises a right hand circularly polarized, RHCP, signal.

7. The device of claim 1, wherein the first, second, and third linearly polarized antennas are positioned within a half a wavelength of each other.

8. The device of claim 7, wherein the wavelength comprises a global positioning system, GPS, wavelength.

9. The device of claim 1, wherein one or more of the first, second, or third linearly polarized antennas is located on an edge of the device.

10. On a mobile device comprising an inertial measurement unit (IMU), and an antenna system comprising a first, a second, and a third linearly polarized antennas, a method comprising:
determining an orientation of the device via the IMU;
receiving a circularly polarized signal via the antenna system;
adjusting one or more of a phase or a gain of a signal on at least one of the first, second, and third linearly polarized antennas based at least in part on the orientation.

11. The method of claim 10, further comprising combining the signals adjusted on the first, second, and third linearly polarized antennas, and decoding the signals combined.

12. The method of claim 10, wherein adjusting the one or more of the phase or the gain comprises adjusting the one or more of the phase or the gain to direct a beam of the antenna system toward a direction of the circularly polarized signal.

13. The method of claim 12, wherein the direction comprises a direction aligned with reference to gravity.

14. The method of claim 12, wherein the direction comprises a direction toward a global positioning system, GPS, satellite.

15. The method of claim 10, wherein receiving the circularly polarized signal comprises receiving a right hand circularly polarized, RHCP, signal.

16. The method of claim 10, wherein adjusting the one or more of the phase or the gain comprises adjusting the one or more of the phase or the gain continuously.

17. On a mobile device comprising an inertial measurement unit, IMU, and an antenna system comprising a first, a second, and a third linearly polarized antennas, a method comprising:
determining an orientation of the device via the IMU;
adjusting one or more of a phase or a gain of a signal on at least one of the first, second, and third linearly polarized antennas based at least in part on the orientation; and
transmitting a circularly polarized signal via the antenna system based at least in part on the one or more of the phase or the gain adjusted of the signal on the at least one of the first, second, and third linearly polarized antennas.

18. The method of claim 17, wherein adjusting the one or more of the phase or the gain comprises, adjusting the one or more of the phase or the gain to direct a beam of the antenna system toward a receiver of the circularly polarized signal.

19. The method of claim 17, wherein transmitting the circularly polarized signal comprises transmitting a right hand circularly polarized (RHCP) signal.

20. The method of claim 17, wherein adjusting the one or more of the phase or the gain comprises adjusting the one or more of the phase or the gain continuously.
